(19) United States
(12) Patent Application Publication
(10) Pub. No.: US 2024/0300042 A1
(43) Pub. Date: Sep. 12, 2024

(54) AUTOMATIC INDEXING FOR CUTTING INSERT

(71) Applicant: KENNAMETAL INC., LATROBE, PA (US)

(72) Inventors: Marcelo Euripedes Silva, Piracicaba (BR); Pavel Pecher, Unicov (CZ)

(73) Assignee: KENNAMETAL INC., LATROBE, PA (US)

(21) Appl. No.: 18/182,351

(22) Filed: Mar. 12, 2023

(51) Int. Cl. B23F 23/08

(52) U.S. Cl. CPC B23F 23/08

(57) ABSTRACT

A cutting system may include a tool and a stationary fixture. The tool may include a cam connected with a cutting insert. The stationary fixture may be spaced apart from the tool. The stationary fixture may include a gear moveable within the stationary fixture. The cam of the tool may be configured to be moved into contact with the gear of the stationary fixture. The stationary fixture may be configured to index the cutting insert.

### FIELD OF THE DISCLOSURE

The disclosure relates to a cutting system which automatically indexes a cutting insert.

### BACKGROUND

Cutting inserts of cutting systems may be indexed to switch-out the portion of the cutting insert doing the cutting to extend the life of the cutting insert. Existing cutting systems and methods of their use often utilize complicated motorized indexing systems. This may lead to additional cost, costly repairs, and more down-time.

An improved cutting system and method of its use is needed to reduce one or more of the issues associated with indexing one or more of the existing cutting systems and methods of their use.

### SUMMARY

In one embodiment, a cutting system may include a tool and a stationary fixture. The tool may include a cam connected with a cutting insert. The stationary fixture may be spaced apart from the tool. The stationary fixture may include a gear moveable within the stationary fixture. The cam of the tool may be configured to be moved into contact with the gear of the stationary fixture. The stationary fixture may be configured to index the cutting insert.

In another embodiment, a cutting system may include a machine, a tool, and a stationary fixture. The tool may include a cutting insert and a cam connected with the cutting insert. The stationary fixture may be spaced apart from the tool. The stationary fixture may include a gear moveably mated with a rack. The machine may be configured to move the cam into contact with the gear of the stationary fixture. The rack may be configured to rotate the gear as the machine moves the tool relative to the stationary fixture. The gear may be configured to rotate the cam causing the cutting insert to index.

In still another embodiment, a method of indexing a cutting insert of a tool is disclosed. In one step, the tool may be moved with a machine to dispose a cam of the tool into contact with a gear of a stationary fixture. In another step, the cutting insert of the tool may be subsequently indexed with the stationary fixture as the machine moves the tool relative to the stationary fixture.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a top perspective view of one embodiment of a cutting system with a tool of the cutting system spaced-apart from a stationary fixture of the cutting system;

FIG. 2 illustrates a bottom perspective view of the cutting system of FIG. 1;

FIG. 3 illustrates a disassembled view of the cutting system of FIG. 1;

FIG. 4 illustrates a top perspective view of the cutting system of FIG. 1 with the tool disposed directly over and spaced-apart from a gear of the stationary fixture in an extended position;

FIG. 5 illustrates a top perspective view of the cutting system of FIG. 4 with a machine of the cutting system having moved a tool holder of the cutting system towards the stationary fixture to dispose a cam of the tool into contact with the gear of the stationary fixture;

FIG. 6 illustrates a top perspective view of the cutting system of FIG. 5 with the machine having advanced the tool holder further towards the stationary fixture with the cam restrained against the gear to force a cutting insert of the tool to move out of a pocket of the tool holder;

FIG. 7 illustrates the top perspective view of the cutting system of FIG. 6 with the machine having moved the tool holder parallel to the stationary fixture with a rack of the stationary fixture causing the gear, cam, and cutting insert to rotate and index;

FIG. 8 illustrates the top perspective view of the cutting system of FIG. 7 with the machine having moved the tool holder away from the stationary fixture causing the cam to separate from the gear causing a biasing member of the tool to relatively move the cutting insert back into the pocket of the tool holder;

FIG. 9 illustrates the top perspective view of the cutting system of FIG. 8 with a biasing member of the stationary fixture having moved the gear back into its extended position;

FIG. 10 illustrates a cross-section view through line 10-10 of FIG. 4 showing a plunger of the tool keeping a rotated position of the cam prior to indexing;

FIG. 11 illustrates a cross-section view through line 11-11 of FIG. 7 showing the plunger of the tool keeping a rotated position of the cam after indexing; and

FIG. 12 illustrates a flowchart showing one embodiment of a method of indexing a cutting tool.

### DETAILED DESCRIPTION

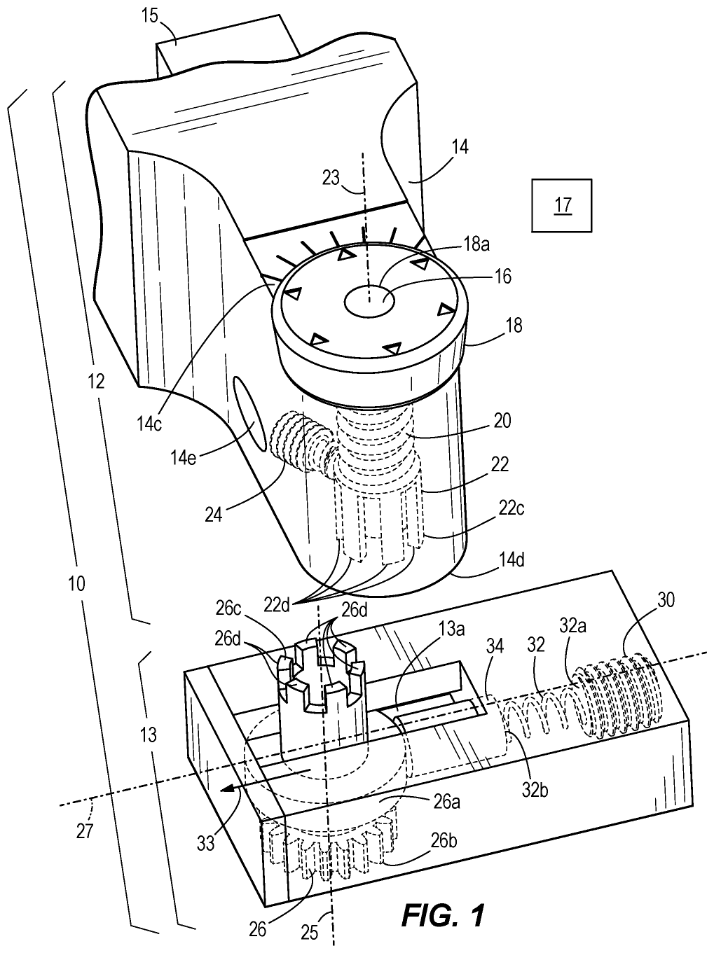

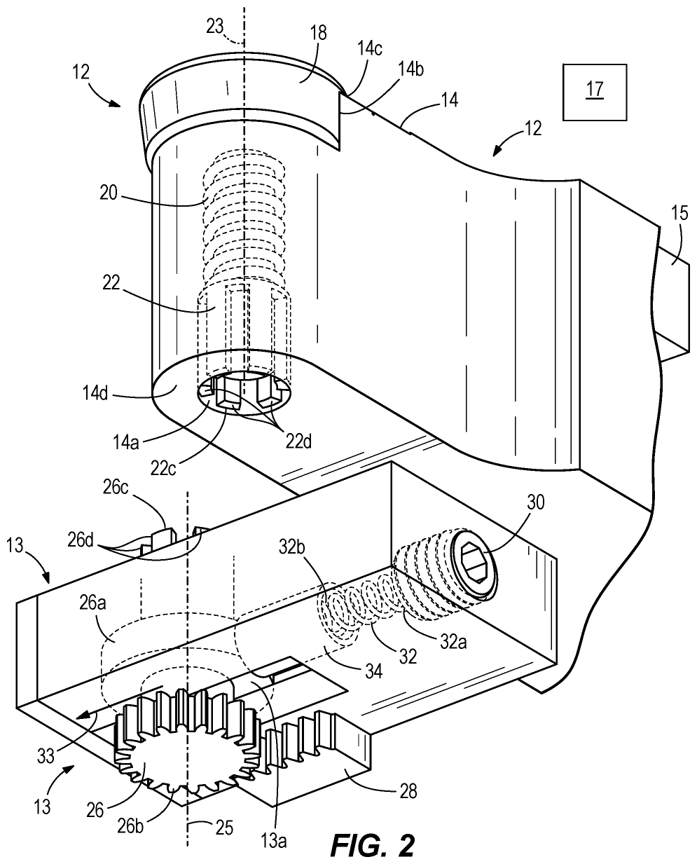

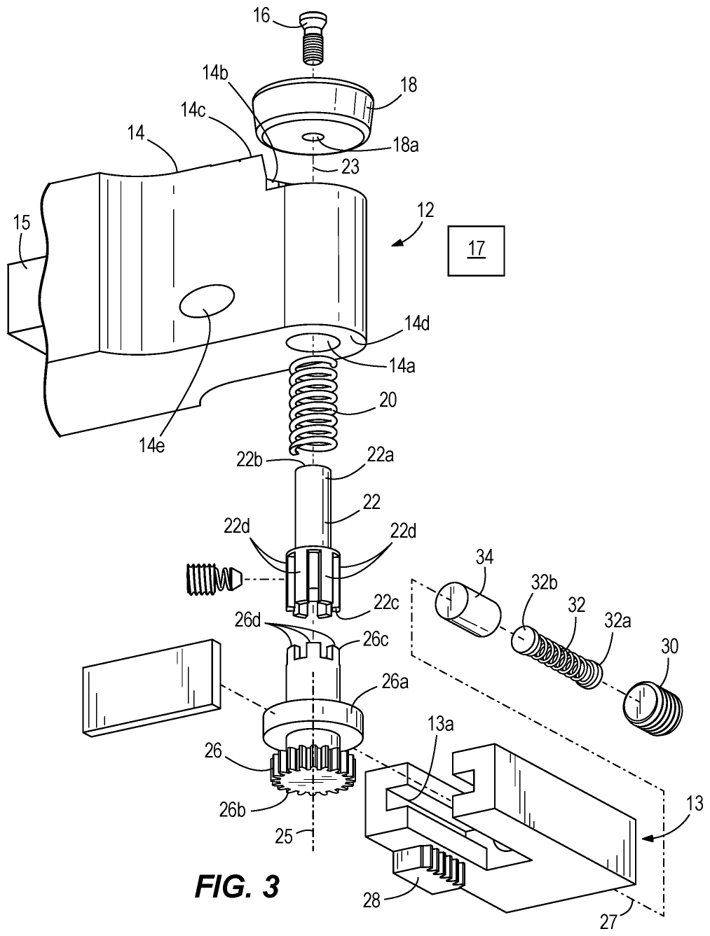

As shown collectively in FIGS. 1-3, in one embodiment a cutting system 10 may include a tool 12, a stationary fixture 13, a machine 15, and a processor 17. The machine 15 may be controlled by the processor 17 to move the tool 12. The machine 15 may comprise an interface of a machine tool.

The tool 12 may comprise a tool holder 14, a fastening member 16, a cutting insert 18, a biasing member 20, a cam 22, and a plunger 24. A shaft 22a of the cam 22 may disposed within a through-hole 14a in the tool holder 14. The biasing member 20 may extend over the shaft 22a in the through-hole 14a of the tool holder 14. The biasing member 20 may comprise a spring. In other embodiments, the biasing member 20 may vary. The fastening member 16 may attach the cutting insert 18 to the cam 22. The fastening member 16 may comprise a screw. The fastening member 16 may extend through a hole 18a in the cutting insert 18 and be threadedly attached to one end 22b of the cam 22 connecting the cam 22 with the cutting insert 18. The cutting insert 18 may be cylindrical. In other embodiments, the cutting insert 18 may vary in shape. The cutting insert 18 may be disposed within and against a pocket 14b at one end 14c of the tool holder 14 with an interference fit preventing the cutting insert 18 from rotating relative to the pocket 14b. The cam 22 and attached cutting insert 18 may be moveably disposed vertically relative to the tool holder 14 along axis 23. This relative movement along axis 23 may allow the cutting insert 18 to be relatively moved vertically out of the interference fit of the pocket 14b to allow the cutting insert 18, and attached cam 22, to rotate around axis 23 relative to the tool holder 14. The biasing member 20 may bias the cutting insert 18 along axis 23 towards the pocket 14b.

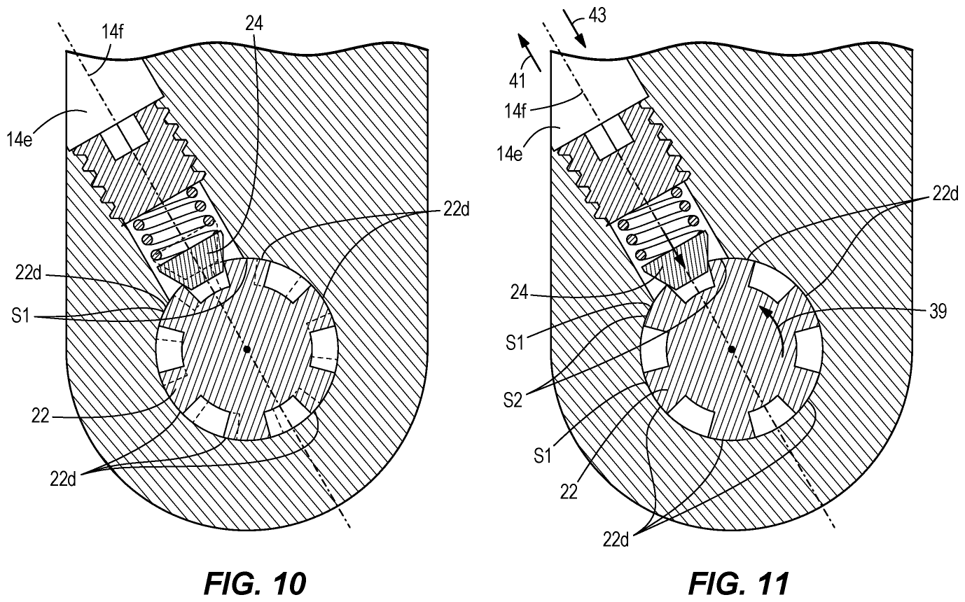

Another end 22c of the cam 22 may comprise mating members 22d disposed within the through-hole 14a adjacent another end 14d of the tool holder 14. The mating members 22d may comprise spaced-apart teeth extending circumferentially around the cam 22. In other embodiments, the mating members 22d may vary in type, shape, configuration, and size. For instance, in another embodiment the mating members 22d may comprise serrated teeth. The plunger 24 may be disposed through a blind-hole 14e in the tool holder 14. The blind-hole 14e may intersect the through-hole 14a. As shown best in FIG. 10, the plunger 24 may be disposed against the cam 22. The plunger 24 may be moveably disposed back and forth along axis 14f within the blind-hole 14e relative to the cam 22 and configured to be disposed between the mating members 22d to keep a rotated position of the cam 22 after each indexing.

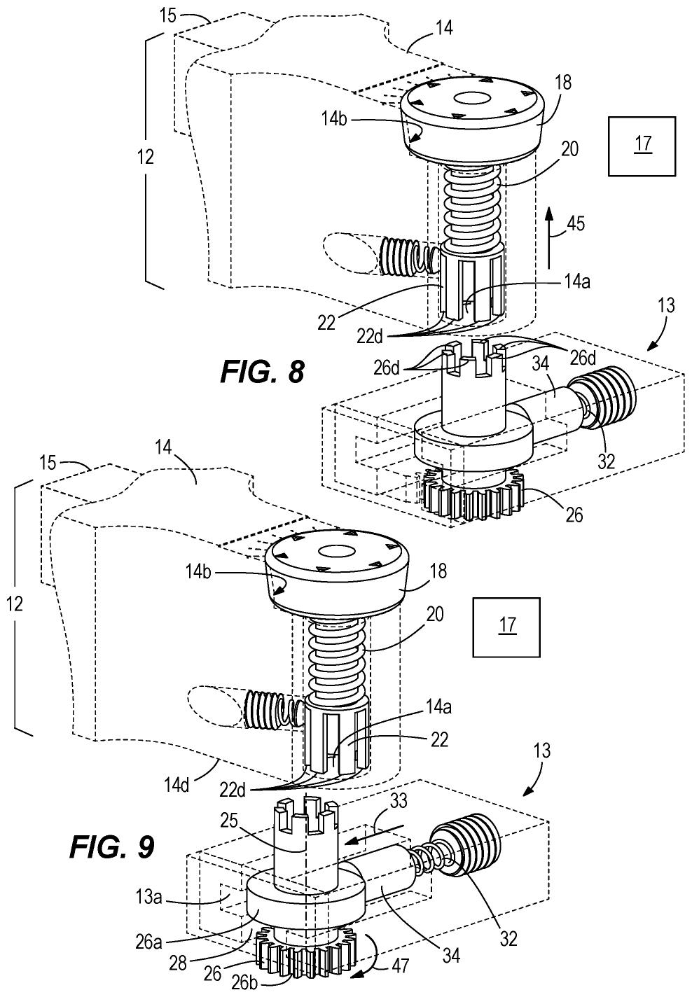

The stationary fixture 13 may be spaced apart from the tool 12. The stationary fixture 13 may comprise a gear 26, a rack 28, a fastener 30, a biasing member 32, and a pin member 34. The stationary fixture 13 and its rack 28 may be stationary within the cutting system 10. The stationary fixture 13 may be rectangular. A middle portion 26a of the gear 26 may be disposed within a slot 13a of the stationary fixture 13. The slot 13a of the stationary fixture 13 may be sized to prevent the middle portion 26 from moving vertically out of the slot 13a in directions 35 and 45 as shown in FIGS. 5 and 8. The gear 26 may rotate around axis 25 while the middle portion 26a of the gear 26 moves laterally along axis 27 within the slot 13a. One end 26b of the gear 26 may mate/mesh with and move relative to the rack 28 causing the entire gear 26 to rotate around axis 25 and move laterally along axis 27. Another end 26c of the gear 26 may comprise mating members 26d. The mating members 26d may extend out of the slot 13a. The mating members 26d may comprise spaced-apart teeth extending circumferentially around the gear 26. In other embodiments, the mating members 26d may vary in type, shape, configuration, and size. For instance, in another embodiment the mating members 26d may comprise serrated teeth.

The fastener 30 may attach to one end 32a of the biasing member 32 attaching the biasing member 32 within the slot 13a of the stationary fixture 13. The biasing member 32 may be disposed within a cylindrical portion of the stationary fixture. The fastener 30 may comprise a screw and the biasing member 32 may comprise a spring. In other embodiments, the fastener 30 and biasing member 32 may vary. The pin member 34 may be attached to the other end 32b of the biasing member 32 within the slot 13a. The middle portion 26a of the gear 26 may be disposed against the pin member 34. The biasing member 32 may bias the gear 26 in direction 33 relative to the rack 28.

As discussed in more detail below, the processor 17 may cause the machine 15 to move the tool 12 relative to the stationary fixture 13 so that the stationary fixture 13 automatically indexes the cutting insert 18. The stationary fixture 13 may be purely mechanical without any motor or electronic components.

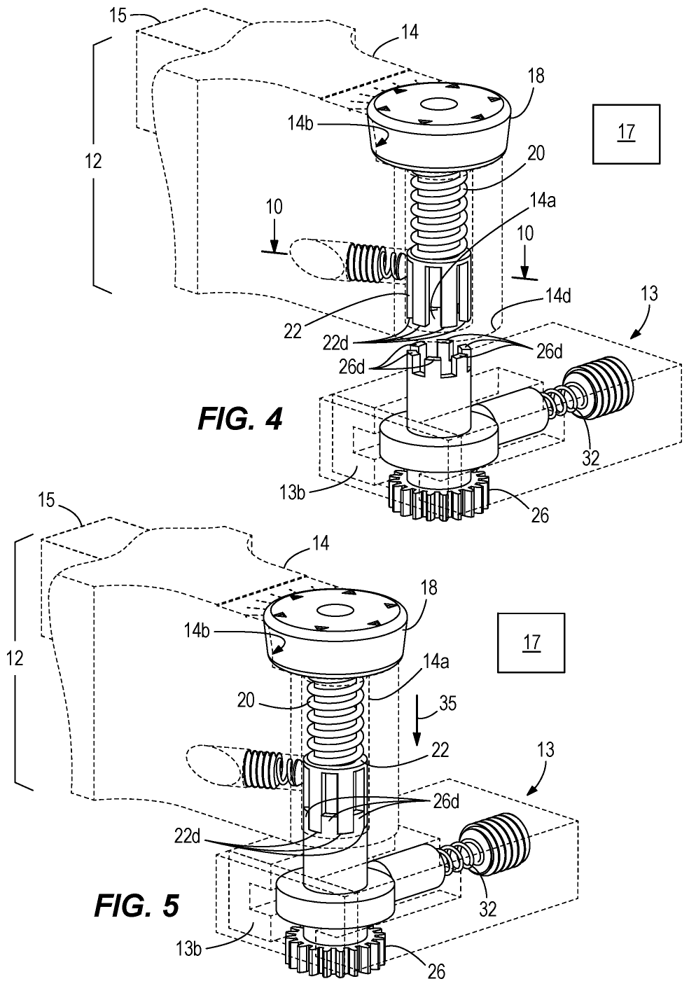

At the start of an indexing action, as shown in FIG. 4, the processor 17 may cause the machine 15 to dispose the tool holder 14 in a raised position with the mating members 22d of the cam 22 disposed in spaced-apart relation directly over the mating members 26d of the gear 26 of the stationary fixture 13. In this position, the tool 12 may be spaced-apart from the stationary fixture 13. The mating members 22d of the cam 22 may be disposed completely within the through-hole 14a of the tool holder 14 adjacent the end 14d of the tool holder 14. Due to the biasing member 20 of the tool 12 biasing the cutting insert 18 towards the pocket 14b, the cutting insert 18 may be disposed within and against the pocket 14b of the tool holder 14 prevented from rotating due to the interference fit of the pocket 14b against the cutting insert 18. As shown best in FIG. 10, the plunger 24 may be disposed in-between a first set S1 of the spaced-apart mating members 22d of the cam 22 keeping a rotated position of the cam 22. The gear 26 of the stationary fixture 13 may be disposed at an end 13b of the stationary fixture 13 due to the biasing member 32 of the stationary fixture 13 biasing the gear 26 to the end 13b.

The processor 17 may then cause the machine 15 to move the tool holder 14 from the position of FIG. 4 in direction 35 towards the stationary fixture 13 to the intermediate position of FIG. 5 with the mating members 22d of the cam 22 coming into contact and mating with the mating members 26d of the gear 26. As shown, the spaced-apart teeth of the mating members 22d may fill the respective spaces between the spaced-apart teeth of the mating members 26d. In this position, the tool 12 may now be in contact with the stationary fixture 13. The mating members 22d of the cam 22 have not yet moved relative to the tool holder 14 within the through-hole 14a of the tool holder 14. Due to the biasing member 20 of the tool 12 biasing the cutting insert 18 towards the pocket 14b, the cutting insert 18 may still be disposed within and against the pocket 14b of the tool holder 14 prevented from rotating due to the interference fit of the pocket 14b against the cutting insert 18. As shown best in FIG. 10, the plunger 24 may still be disposed in-between the first set S1 of the spaced-apart mating members 22d of the cam 22 keeping the rotated position of the cam 22. The gear 26 of the stationary fixture 13 may still be disposed at the end 13b of the stationary fixture 13 due to the biasing member 32 of the stationary fixture 13 biasing the gear 26 to the end 13b.

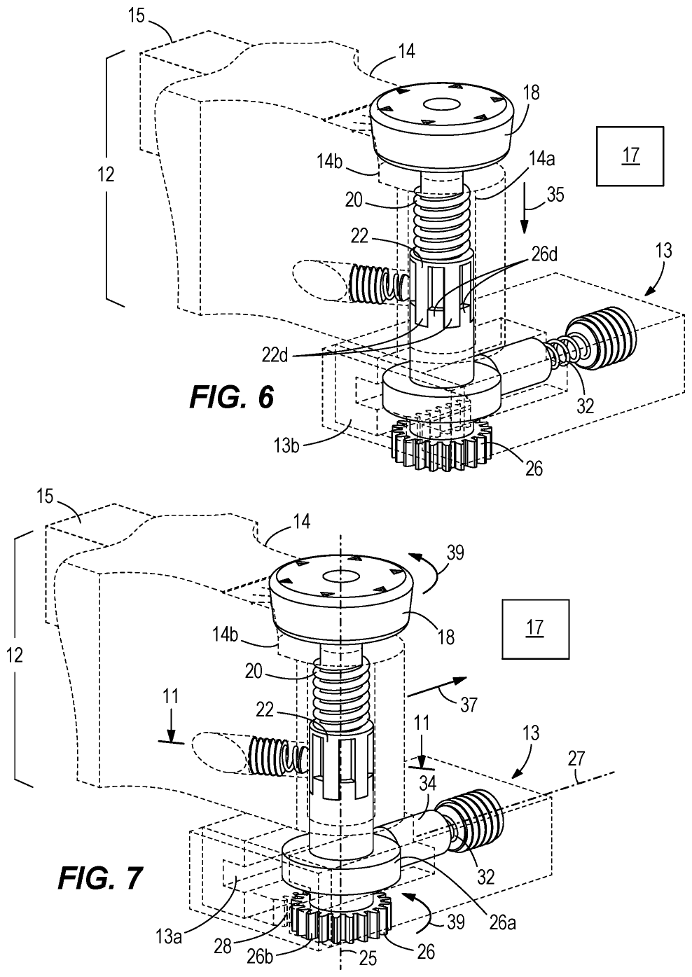

The processor 17 may then cause the machine 15 to move the tool holder 14 from the position of FIG. 5 further in direction 35 towards the stationary fixture 13 to the lowered position of FIG. 6 with the mating members 22d of the cam 22 prevented by the mating members 26d of the gear 26 from moving further in direction 35. This may cause the cam 22 to move relative to the tool holder 14 within the through-hole 14a of the tool holder 14 due to the tool holder 14 moving in direction 35 relative to the cam 22 which may be stationary. This movement of the tool holder 14 relative to the cam 22 may cause the cutting insert 18 to be relatively moved away from the pocket 14b of the tool holder 14. During this movement of the tool holder 14 in direction 35, the biasing member 20 of the tool 12 may be compressed in direction 35. The movement of the tool holder 14 relative to the cutting insert 18 may cause the cutting insert 18 to no longer be constrained from rotation due to the interference fit of the pocket 14b having been removed from the cutting insert 18. As shown best in FIG. 10, the plunger 24 may still be disposed in-between the first set S1 of the spaced-apart mating members 22d of the cam 22 keeping the rotated position of the cam 22. The gear 26 of the stationary fixture 13 may still be disposed at the end 13b of the stationary fixture 13 due to the biasing member 32 of the stationary fixture 13 biasing the gear 26 to the end 13b.

The processor 17 may then cause the machine 15 to move the tool holder 14 from the position of FIG. 6 in direction 37 parallel to axis 27 of the slot 13a of the stationary fixture 13 into the position of FIG. 7. The movement of the tool holder 14 in direction 37 may cause end 26b of the gear 26 to rotate in direction 39 around axis 25 as it meshes/mates with the rack 28 of the stationary fixture 13. As the gear 26 rotates in direction 39, the middle portion 26a of the gear 26 may move in direction 37 within the slot 13a of the stationary fixture 13. This may cause the entire gear 26 to move in direction 37. As the gear 26 rotates in direction 39 and simultaneously moves in direction 37, the attached cam 22 and attached cutting insert 18 may rotate with the gear 26 in direction 39 and may simultaneously move with the gear 26 in direction 37. This may cause the cutting insert 18 and cam 22 to index. This rotation of the cutting insert 18 may be allowed due to the cutting insert 18 being disposed outside of the interference fit of the pocket 14b of the tool holder 14. During this movement, the biasing member 20 of the tool 12 may remain compressed, while the biasing member 32 of the stationary fixture 13 may compress in direction 37 as the middle portion 26a of the gear 26 pushes the pin member 34 and the biasing member 32 in direction 37. As best shown in FIG. 11, as the cam 22 rotates in direction 39 the plunger 24 may retract along axis 14f in direction 41 and, due to the rotation of the cam 22 relative to the plunger 24, may then move in direction 43 to be disposed between a second set S2 of the mating members 22d, different from the first set 21 of the mating members 22d, to keep the rotated position of the cam 22 after the cutting insert 18 is indexed.

The processor 17 may then cause the machine 15 to move the tool holder 14 from the position of FIG. 7 in direction 45 away from the stationary fixture 13 into the raised position of FIG. 8. This movement of the tool holder 14 may cause the mating members 22d of the cam 22 to also move in direction 45 away from the stationary fixture 13 to again be disposed in spaced-apart relation directly over the mating members 26d of the gear 26 of the stationary fixture 13. In this position, the tool 12 may be spaced-apart from the stationary fixture 13. When the mating members 22d of the cam 22 are no longer in contact with the mating members 26d of the gear 26 of the stationary fixture 13, the biasing member 20 of the tool 12 may again force the cutting insert 18 back into the pocket 14b as the tool holder 14 moves in direction 45. This may cause the cutting insert 18 to again be held in the pocket 14b with an interference fit so that the cutting insert 18 may no longer rotate. At this time, the mating members 22d of the cam 22 may be disposed completely within the through-hole 14a of the tool holder 14 adjacent the end 14d of the tool holder 14. As best shown in FIG. 11, the plunger 24 may remain in its position between the second set S2 of the mating members 22d of the cam 22 keeping the rotated position of the cam 22 after the cutting insert 18 was indexed. The biasing member 32 of the stationary fixture 13 may for a moment remain compressed due to the force of the middle portion 26a of the gear 26 pushing the pin member 34 against the biasing member 32.

The biasing member 32 of the stationary fixture 13 may then cause the gear 26 of the stationary fixture 13 to move from its position of FIG. 8 into its position of FIG. 9 which matches the initial position of the gear 26 of the stationary fixture 13 in FIG. 4. The biasing member 32 of the stationary fixture 13 may push the pin member 34 and the middle portion 26a of the gear 26 in direction 33 to cause end 26b of the gear 26 to rotate in direction 47 around axis 25 as it meshes/mates with the rack 28. As the gear 26 rotates in direction 47, the middle portion 26a of the gear 26 may move in direction 33 within the slot 13a of the stationary fixture 13. This may cause the entire gear 26 to move in direction 33. During this movement of the gear 26 of the stationary fixture 13, the processor 17 may cause the machine 15 to keep the tool holder 14 in the raised position away from the stationary fixture 13. During this time, due to the biasing member 20 of the tool 14, the cutting insert 18 may be kept in its same position in the pocket 14b of the tool holder 14 with the interference fit preventing the cutting insert 18 from rotating. The mating members 22d of the cam 22 may remain completely disposed within the through-hole 14a of the tool holder 14 adjacent the end 14d of the tool holder 14. As best shown in FIG. 11, the plunger 24 may remain in its position between the second set S2 of the mating members 22d of the cam 22 keeping the rotated position of the cam 22 after the cutting insert 18 was indexed.

The processor 17 may then cause the machine 15 to move the tool holder 14 from the position of FIG. 9 in direction 33 back into its position relative to the stationary fixture 13 shown in FIG. 4. This may cause the entire tool 12 to be disposed in its same position relative to the stationary fixture 13 as shown in FIG. 4. The processor 17 may then cause the machine 15 to repeat the same process described above in FIGS. 4-11 to continually index the cutting insert 18 using the stationary fixture 13.

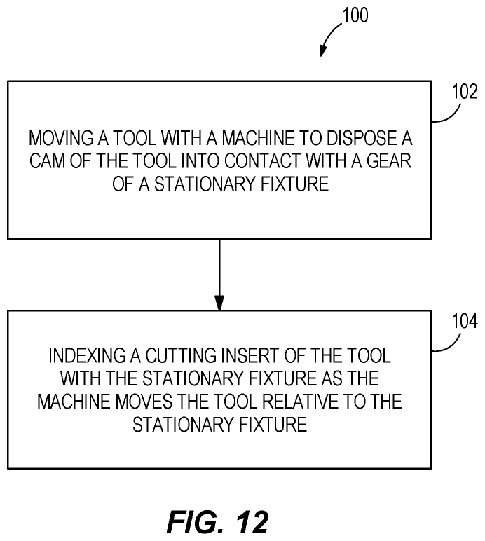

FIG. 12 illustrates one embodiment of a method 100 of indexing a cutting insert of a tool. The method 100 may utilize any of the embodiments of the cutting system of FIGS. 1-11. In other embodiments the method 100 may utilize varying cutting systems.

In step 102, the tool may be moved with a machine to dispose a cam of the tool into contact with a gear of a stationary fixture. Subsequently, in step 104, the cutting insert of the tool may be indexed with the stationary fixture as the machine moves the tool relative to the stationary fixture. Step 104 may be done automatically using the stationary fixture. The stationary fixture may be purely mechanical without any motor or electronic components.

In another embodiment, the method 100 may further comprise preventing rotation of the cutting insert within a pocket of a tool holder of the tool.

In an additional embodiment, the method 100 may further comprise moving a pocket of a tool holder relatively away from the cutting insert to allow the cutting insert to rotate. In one embodiment, the step of moving the pocket of the tool holder relatively away from the cutting insert may comprise the machine moving the tool holder relative to the cam of the tool while the cam of the tool is restrained against the gear of the stationary fixture causing the pocket of the tool holder to move relatively away from the cutting insert.

In yet another embodiment, step 104 may comprise the gear of the stationary fixture moving relative to a rack of the stationary fixture causing the cam to rotate which causes the cutting insert of the tool to index.

In an additional embodiment, the method 100 may further comprise keeping a rotated position of the cam with a plunger after the cutting insert is indexed.

In another embodiment, the method 100 may further comprise the machine moving a tool holder of the tool away from the stationary fixture and a biasing member of the tool moving the cutting insert into a pocket of the tool holder to prevent the cutting insert from rotating.

In still another embodiment, the method 100 may further comprise a biasing member of the stationary fixture moving the gear of the stationary fixture relative to the stationary fixture.

In an additional embodiment, the method 100 may further comprise any of the steps of operating the cutting system of FIGS. 1-11 as described above.

In other embodiments, one or more steps of the method 100 may vary in substance and/or in order, one or more steps of the method 100 may not be followed, and/or one or more additional steps may be added to the method 100.

The cutting systems and methods described herein may utilize purely mechanical stationary fixtures to automatically index their cutting inserts. This may result in a reduction of manufacturing cost, a reduction in repair cost, and less down-time of the cutting system.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A cutting system comprising:
a tool comprising a cam connected with a cutting insert; and
a stationary fixture spaced apart from the tool, the stationary fixture comprising a gear moveable within the stationary fixture;
wherein the cam of the tool is configured to be moved into contact with the gear of the stationary fixture, and the stationary fixture is configured to index the cutting insert.

2. The cutting system of claim 1 wherein the tool further comprises a plunger disposed against the cam, the plunger moveable relative to the cam and configured to keep a rotated position of the cam after the cutting insert is indexed.

3. The cutting system of claim 1 wherein the stationary fixture comprises a rack and gear, the rack configured to rotate the gear, the gear configured to rotate the cam causing the cutting insert to index.

4. The cutting system of claim 3 wherein the stationary fixture comprises a biasing member biasing the gear relative to the rack.

5. The cutting system of claim 1 further comprising a machine, the machine configured to move the cam of the tool into contact with the gear of the stationary fixture, the stationary fixture configured to index the cutting insert as the machine moves the tool relative to the stationary fixture.

6. The cutting system of claim 1 wherein the tool comprises a tool holder comprising a pocket, the cutting insert disposed within and against the pocket with an interference fit preventing the cutting insert from rotating relative to the pocket, the pocket configured to be relatively moved away from the cutting insert allowing the cutting insert to rotate.

7. The cutting system of claim 6 wherein the tool comprises a biasing member biasing the cutting insert towards the pocket.

8. A cutting system comprising:
a machine;
a tool comprising a cutting insert and a cam connected with the cutting insert; and
a stationary fixture spaced apart from the tool, the stationary fixture comprising a gear moveably mated with a rack;
wherein the machine is configured to move the cam into contact with the gear of the stationary fixture, the rack is configured to rotate the gear as the machine moves the tool relative to the stationary fixture, and the gear is configured to rotate the cam causing the cutting insert to index.

9. The cutting system of claim 8 wherein the tool further comprises a plunger disposed against the cam, the plunger moveable relative to the cam and configured to keep a rotated position of the cam after the cutting insert is indexed.

10. The cutting system of claim 8 wherein the stationary fixture comprises a biasing member biasing the gear relative to the rack.

11. The cutting system of claim 8 wherein the tool comprises a tool holder comprising a pocket, the cutting insert disposed within and against the pocket with an interference fit preventing the cutting insert from rotating relative to the pocket, the pocket configured to relatively move away from the cutting insert allowing the cutting insert to rotate.

12. The cutting system of claim 11 wherein the tool comprises a biasing member biasing the cutting insert towards the pocket.

13. A method of indexing a cutting insert of a tool comprising:
moving the tool with a machine to dispose a cam of the tool into contact with a gear of a stationary fixture; and
subsequently indexing the cutting insert of the tool with the stationary fixture as the machine moves the tool relative to the stationary fixture.

14. The method of claim 13 further comprising preventing rotation of the cutting insert within a pocket of a tool holder of the tool.

15. The method of claim 13 further comprising moving a pocket of a tool holder relatively away from the cutting insert to allow the cutting insert to rotate.

16. The method of claim 15 wherein the moving the pocket of the tool holder relatively away from the cutting insert comprises the machine moving the tool holder relative to the cam of the tool while the cam of the tool is restrained against the gear of the stationary fixture causing the pocket of the tool holder to move relatively away from the cutting insert.

17. The method of claim 13 wherein the subsequently indexing the cutting insert of the tool with the stationary fixture as the machine moves the tool relative to the stationary fixture comprises the gear of the stationary fixture moving relative to a rack of the stationary fixture causing the cam to rotate which causes the cutting insert of the tool to index.

18. The method of claim 13 further comprising keeping a rotated position of the cam with a plunger after the cutting insert is indexed.

19. The method of claim 13 further comprising the machine moving a tool holder of the tool away from the stationary fixture and a biasing member of the tool moving the cutting insert into a pocket of the tool holder to prevent the cutting insert from rotating.

20. The method of claim 13 further comprising a biasing member of the stationary fixture moving the gear of the stationary fixture relative to the stationary fixture.
